(19) United States
(12) Patent Application Publication
(10) Pub. No.: US 2009/0270551 A1
(43) Pub. Date: Oct. 29, 2009

(54) Polymer and Composition

(76) Inventors: Olivier Dupont, Chastre (BE); Singa Tobing, Springfield, MA (US); Hui Liu, San Diego, CA (US)

Correspondence Address: WENDEROTH, LIND & PONACK, L.L.P., 1030 15th Street, N.W.,, Suite 400 East, Washington, DC, 20005-1503, US

(21) Appl. No.: 11/991,557

(22) PCT Filed: Sep. 7, 2006
(86) PCT No.: PCT/EP2006/008704

§ 371 Date: Apr. 30, 2008

Related U.S. Application Data
(60) Provisional application No. 60/714,839, filed on Sep. 8, 2005.

(51) Int. Cl. C08L 33/06; C08F 20/10; C08F 20/06

(52) U.S. Cl. 524/560; 526/318; 526/318.6

(57) ABSTRACT

There is disclosed a polymer (Polymer P) which is obtained and/or is obtainable from a monomer composition comprising (a) from about 5% to about 95% by weight of at least one C₂₋₁₂alkyl acrylate; (b) from about 2.5% to about 60% by weight of at least one polymer precursor selected from the group consisting of: C₁₋₃₀ alkyl(meth)acrylates, C₂₋₃₀ vinyl aromatic compounds, C₂₋₃₀ vinyl halides, C₂₋₃₀ vinyl nitriles, C₂₋₃₀ vinyl esters of carboxylic acids and mixtures thereof; with the provisos that (i) the homopolymers of each of said polymer precursor(s) have a T_{g} above about −25° C.; and (ii) each of said polymer precursor(s) comprises other than a functional group selected from the group consisting of: hydroxy, carboxy, acid anhydride, nitro, epoxy and amino; (c) from about 0.1% to about 2% by weight of at least one polymer precursor comprising at least one activated unsaturated moiety (conveniently ethylenically unsaturated monomer) having at least one carboxy and/or acid anhydride group(s); and (d) optionally up to about 60% by weight of at least one further optionally substituted polymer precursor comprising at least one activated unsaturated moiety (conveniently ethylenically unsaturated monomer) where the further optional substituent(s) are other than carboxy and/or acid anhydride group(s) where each of the constituents ‘a’, ‘b’ and ‘c’ and optionally constituent ‘d’ are different from each other with the additional proviso that Polymer P was obtained and/or is obtainable by polymerisation of the each of the constituents ‘a’, ‘b’ and ‘c’ and optionally constituent ‘d’ in the presence of a water soluble initiator in an amount above about 0.35% and optionally up to about 2% by weight of the total monomer composition.

The invention relates to the field of aqueous polymer dispersions, to their use for example as adhesives and to the preparation of the polymers and their dispersions.

Pressure sensitive adhesives (PSA) form a permanently adhesive film capable of adhering to various surfaces upon slight pressure at ambient temperature. PSAs are used to manufacture self-adhesive products, such as labels, tapes or films, and are easy to handle and allow faster processing then conventional adhesives as neither curing nor solvent evaporation is required.

The quality of a substrate applied with a self-adhesive film usually depends on balancing the internal strength within the material (cohesion) and the external affinity to the substrate (adhesion). For PSAs a high degree of cohesion (i.e. shear strength) is required to produce self-adhesive films that firmly remain on the substrate under manufacturing conditions of the self adhesive products (e.g. during cutting, stamping, etc.). At the same time, the adhesion (i.e. the peel strength and loop tack) to the product should meet the requirements for the intended use. It is difficult to achieve the optimum balance between adhesion and cohesion in a PSA.

A further problem with PSAs is an undesirable loss of peel strength upon aging when the PSA is applied to a substrate and/or face stock which contain plasticizers. For example vinyl substrates (e.g. banners, binders and containers) and vinyl face stocks (e.g. films and vinyl) may contain plasticizers such as dioctlyphthalate (referred to herein as DOP) and/or dinonylphthalate (referred to herein as DINP). Decrease of peel strength is caused by the migration of the plasticizers from the substrate and/or face stock into the adhesive film which eventually leads to adhesion failure.

An additional problem is that when a vinyl film is used face stock, the laminate shrinks on aging. This phenomenon is related both to the migration of the plasticizer into the adhesive film, but also to the release of stresses caused to the vinyl film during the film manufacturing process (known as calendaring).

Emulsion adhesives are generally preferred for environmental and cost reasons as aqueous polymer dispersions are typically non-hazardous and less expensive than other technologies (e.g. solution in organic solvent, or UV curable adhesives).

Therefore a PSA with improved resistance to plasticizer would be generally desired so PSAs can be used with plasticizer-containing substrates. It would be particularly desirable to provide a PSA which substantially maintains its peel performance and resist shrinkage when applied to plasticizer-containing face stock as this would extend the life of the product.

It is an object of the invention to provide aqueous polymer dispersions, which are suitable as adhesives (e.g. PSA) and address some or all of the problems identified herein.

The applicant has surprisingly found that certain aqueous polymer dispersions can be applied as an adhesive to a vinyl film face stock and maintain peel strength upon aging and exhibit improved resistance to shrinkage.

Therefore broadly in accordance with the present invention there is provided a polymer (Polymer P) which is obtained and/or is obtainable from a monomer composition comprising:

(a) from about 5% to about 95% by weight of at least one C₂₋₁₂alkyl acrylate (constituent a);
(b) from about 2.5% to about 60% by weight of at least one polymer precursor selected from the group consisting of: C₁₋₃₀ alkyl(meth)acrylates, C₂₋₃₀ vinylaromatic compounds, C₂₋₃₀ vinyl halides, C₂₋₃₀ vinyl nitrites, C₂₋₃₀ vinyl esters of carboxylic acids and mixtures thereof; with the provisos that
(i) the homopolymers of each of said polymer precursor(s) have a T_{g} above about −25° C.; and
(ii) each of said polymer precursor(s) comprises other than a functional group selected from the group consisting of: hydroxy, carboxy, acid anhydride, nitro, epoxy and amino (constituent b);
   (c) from about 0.1% to about 2% by weight of at least one polymer precursor comprising at least one activated unsaturated moiety (conveniently at least one ethylenically unsaturated monomer) having at least one carboxy and/or acid anhydride group(s) (constituent c); and
   (d) optionally up to about 60% by weight of at least one further optionally substituted polymer precursor comprising at least one activated unsaturated moiety, (conveniently at least one ethylenically unsaturated monomer) where the further optional substituent(s) are other than carboxy and/or an acid anhydride group(s) (constituent d).

where each of the constituents ‘a’, ‘b’ and ‘c’ and optionally constituent ‘d’ are different from each other

with the additional proviso that Polymer P was obtained and/or is obtainable by polymerisation of the each of the constituents ‘a’, ‘b’ and ‘c’ and optionally constituent ‘d’ in the presence of a water soluble initiator in an amount above about 0.35% and optionally up to about 2% by weight of the total monomer composition.

Preferably the monomer composition consisting essentially of constituents ‘a’, ‘b’ and ‘c’ and optionally constituent ‘d’.

The values given in the monomer constituents as % by weight are calculated based on the total weight of the polymer.

In accordance with another aspect of the invention there is provided an aqueous dispersion comprising Polymer P.

In accordance with a yet other aspect of the invention there is provided a PSA comprising Polymer P.

Further aspects of the invention and preferred features thereof are given in the claims herein. Many other variations embodiments of the invention will be apparent to those skilled in the art and such variations are contemplated within the broad scope of the present invention.

Unless the context clearly indicates otherwise, as used herein plural forms of the terms herein are to be construed as including the singular form and vice versa.

The term “comprising” as used herein will be understood to mean that the list following is non-exhaustive and may or may not include any other additional suitable items, for example one or more further feature(s), component(s), ingredient(s) and/or substituent(s) as appropriate. In contrast the term “consisting essentially of” as used herein will be understood to mean that the list following is exhaustive and does not include any additional items.

The PSA of the present invention has excellent resistance to plasticizers. The applicant has found that compared to prior art PSAs (i.e. those obtained with <0.35% by weight of initiator) the peel value reduces less when the adhesive laminate (comprising a plasticized substrate) is aged at 80° C. for 2 days. The applicant has further found that PSAs of the present invention exhibit excellent shrinkage resistance when the adhesive film, applied on glass, is aged at 70° C. for 7 days.

A polymer which comprises constituents ‘a’, ‘b’, ‘c’ and ‘d’ may also comprise, for example, fragments of radical initiators and/or chain transfer agents covalently bonded to the polymer. Compounds which are usually not interpreted as polymerisable monomers, such as initiators or chain transfer agents, are preferably not constituents of Polymer P.

### Monomer Constituents

Constituent ‘a’ (‘soft’ monomer)

Preferably the monomer(s) for constituent ‘a’ comprise at least one C₁₋₂₀alkyl acrylate the homopolymers of which have a T_{g} of less than or equal to about −40° C., more preferably comprise one or more C₁₋₁₀alkyl acrylates; and most preferably comprise at least one monomer selected from the group consisting of n-butyl acrylate, 2-ethylbutyl acrylate, hexyl acrylate, 2-ethylhexyl acrylate, nonyl acrylate, n-octyl acrylate and mixtures thereof. The monomers n-butyl acrylate and 2-ethylhexyl acrylate are particularly preferred for example 2-ethyl hexyl acrylate.

Conveniently constituent ‘a’ comprises from about 5% to about 95%; more conveniently from about 55% to about 80%; most conveniently from about 60% to about 70% by weight of the total weight of Polymer P.

### Constituent ‘b’ (Hard Monomer)

The monomers for constituent ‘b’ comprise at least one monomer to be selected from the group consisting of: C₁₋₃₀ alkyl(meth)acrylates, C₂₋₃₀ vinylaromatic compounds, C₂₋₃₀ vinyl halides, C₂₋₃₀ vinyl nitriles, C₂₋₃₀ vinyl esters of carboxylic acids and mixtures thereof; the homopolymers of which have a T_{g} of from about and above −25° C. Preferably the monomer(s) for constituent ‘b’ comprise at least one C₁₋₃₀alkyl (meth)acrylates, more preferably comprise one or more C₁₋₁₂alkyl(meth)acrylates: and most preferably comprise at least one monomer selected from the group consisting of ethyl acrylate, sec-butyl acrylate, dodecyl acrylate, isobutyl acrylate, methyl acrylate, n-butyl methacrylate, methyl methacrylate, tert-butyl acrylate, sec-propyl acrylate and mixtures thereof. The monomers methyl acrylate, methyl methacrylate and/or mixtures thereof are particularly preferred.

Conveniently constituent ‘b’ comprises from about 2.5% to about 60%, more conveniently from about 8% to about 50%, most conveniently from about 15% to about 40% by weight of the total weight of Polymer P.

### Constituent ‘c’ (Low Acid Content)

Preferably the monomer(s) for constituent ‘c’ comprise: ethylenically unsaturated compounds comprising carboxyl groups, ethylenically unsaturated acid anhydrides and/or ethylenically unsaturated monoesters of ethylenically unsaturated diacids and/or triacids; more preferably comprise at least one monomer selected from the group consisting of (meth)acrylic acid; maleic acid, maleic acid anhydride, maleic acid monoester, fumaric acid monoester and mixtures thereof. The monomers acrylic acid and methacrylic acid are particularly preferred for example methacrylic acid.

Constituent ‘c’ is present in low amounts as it is preferred that the acid content of the monomer composition is corresponding reduced. Conveniently constituent ‘c’ comprises from about 0.1% to about 3%, more conveniently from about 0.2% to about 2.5%, and most conveniently from about 0.5% to about 2%, for example from about 1% to about 2% by weight of the total weight of Polymer P.

### Optional Constituent ‘d’ (Other Functional Monomers)

Preferably the monomer(s) for constituent ‘d’ comprise those ethylenically unsaturated compounds which customarily enhance the internal strength and/or adhesion of the films formed from an aqueous polymer dispersion comprising Polymer P. In addition to an ethylenically unsaturated group these compounds may comprise either no further functional group or one or more further functional group(s) preferably selected from the group consisting of epoxy, hydroxyl, ethyl imidazolidone, N-methylol, carbonyl; and/or a further ethylenically unsaturated group(s) which is not conjugated with other ethylenically unsaturated group(s). The further functional group(s) may only comprise an acid or an acid anhydride group if additionally one or more additional further functional groups other than the acid or an acid anhydride group are also present in the molecule.

More preferred further functional groups are selected from any suitable organo group such as those described later herein.

Most preferred further functional group(s) are selected from. —OR, —OOR, —SR, —SSR, —COR, —COX, —CO₂R, —OCO₂R, —OCONRR′, —NRCO₂R′, —CONRR′, —NRCONR′R″, —NRR′, —NRNR′R″, —NO₂, —NO, —SOR, —SO₂R, —CR═CR′R″, —C≡CR, —X, —N₃, —N═NR, —C═NR, —CN, —NC, —NCO, —OCN, —NCS, —SCN, —Si(OR)₃, —CNRNR′R″, —NRCNR′NR″R′″, —PO(OR)₂, —OPO(OR)₂, —SO₃R, —OSO₃R, -aryl, and/or -heteroaryl, where:

R, R′, R″ and R′″ independently represent hydrogen or C₁₋₂₄hydrocarbo and X represents halo.

These most preferred functional groups listed above may also comprise their cyclic analogues: for example, —OR includes oxiranes, —SR includes thiiranes, —CONRR′ includes lactames and —CO₂R includes lactones. The most preferred functional groups may also be combined. For example, the combination of a carbonyl group and a heteroaryl group, such as imidazole, leads to an imidazolone.

Further functional group(s) preferred in particular comprise epoxy, ethyl imidazolidone, hydroxy, N-methylol, carbonyl and/or a further ethylenically unsaturated group which is not conjugated with the other ethylenically unsaturated group. For example constituent ‘d’ may comprise ethyl imidazolidone methacrylate and derivatives thereof (such as those monomers available commercially from Arkema under the trade marks Norsocryl® 102 and Norsocryl® 104) and/or hexanedioldiacrylate (HDDA).

The ethylenically unsaturated compounds for constituent ‘d’ do not include any of compounds for constituents ‘a’, ‘b’ and/or ‘c’. Conveniently constituent ‘d’ comprises=<about 25%, more conveniently=<about 20%, most conveniently from about 0.1% to about 10%, in particular from about 0.1% to about 2% by weight of the total weight of Polymer P.

Optionally other ingredients (such as formaldehyde) may be used during the preparation of the polymers of the invention to increase the amount of cross-linking with the functional monomer.

### Initiator

To obtain a polymer of the present invention having enhanced plasticizer resistance the applicant has found that a larger amounts of total initiator should be used that is conventional for known PSAs optionally above about 0.2% by weight. Preferably the total amount of initiator is from about 0.2 to about 2%, more preferably from about 0.35% to about 2%, most preferably from about 0.4% to about 1.0%, for example from about 0.4% to about 0.7% by weight based on the total weight of the monomers to be polymerized. It is also possible to use a single initiator or mixture of different initiators.

Preferred initiators are any suitable for initiating free radical polymerization more preferably those that suitable for initiating a radical aqueous emulsion polymerization. Advantageously the initiator is a peroxide, more advantageously is selected from peroxydisulfates such as alkali metal and/or ammonium salts thereof. Other suitable initiators may be redox-initiator systems, such as those selected from the group consisting of the ascorbic acid/Fe(II) sulfate/sodium peroxydisulfate system; the tert-butylhydroperoxide/sodium disulfite system and/or the tert-butylhydroperoxide/sodium hydroxymethanesulfinic acid system. Other suitable inititators will be well know to those skilled in the art.

### Optional Substituents

The terms ‘optional substituent’ and/or ‘optionally substituted’ as used herein (unless followed by a list of other substituents) signifies the one or more of following groups (or substitution by these groups): carboxy, sulfo, formyl, hydroxy, amino, imino, nitrilo, mercapto, cyano, nitro, methyl, methoxy and/or combinations thereof. These optional groups include all chemically possible combinations in the same moiety of a plurality (preferably two) of the aforementioned groups (e.g. amino and sulfonyl if directly attached to each other represent a sulfamoyl group). Preferred optional substituents comprise: carboxy, sulfo, hydroxy, amino, mercapto, cyano, methyl, halo, trihalomethyl and/or methoxy.

The synonymous terms ‘organic substituent’ and “organic group” as used herein (also abbreviated herein to “organo”) denote any univalent or multivalent moiety (optionally attached to one or more other moieties) which comprises one or more carbon atoms and optionally one or more other heteroatoms. Organic groups may comprise organoheteryl groups (also known as organoelement groups) which comprise univalent groups containing carbon, which are thus organic, but which have their free valence at an atom other than carbon (for example organothio groups). Organic groups may alternatively or additionally comprise organyl groups which comprise any organic substituent group, regardless of functional type, having one free valence at a carbon atom. Organic groups may also comprise heterocyclyl groups which comprise univalent groups formed by removing a hydrogen atom from any ring atom of a heterocyclic compound: (a cyclic compound having as ring members atoms of at least two different elements, in this case one being carbon). Preferably the non carbon atoms in an organic group may be selected from: hydrogen, halo, phosphorus, nitrogen, oxygen, silicon and/or sulfur, more preferably from hydrogen, nitrogen, oxygen, phosphorus and/or sulfur. Convenient phosphorous containing groups may comprise: phosphinyl (i.e. a ‘—PR₃’ radical where R independently denotes H or hydrocarbyl); phosphinic acid group(s) (i.e. a ‘—P(═O)(OH)₂’ radical); and phosphonic acid group(s) (i.e. a ‘—P(═O)(OH)₃’ radical). Halo denotes F, Cl, Br or I, preferred halo are F, Cl, Br most preferred are F and Cl.

Most preferred organic groups comprise one or more of the following carbon containing moieties: alkyl, alkoxy, alkanoyl, carboxy, carbonyl, formyl and/or combinations thereof; optionally in combination with one or more of the following heteroatom containing moieties: oxy, thio, sulfinyl, sulfonyl, amino, imino, nitrilo and/or combinations thereof. Organic groups include all chemically possible combinations in the same moiety of a plurality (preferably two) of the aforementioned carbon containing and/or heteroatom moieties (e.g. alkoxy and carbonyl if directly attached to each other represent an alkoxycarbonyl group).

The term ‘hydrocarbo group’ as used herein is a sub-set of a organic group and denotes any univalent or multivalent moiety (optionally attached to one or more other moieties) which consists of one or more hydrogen atoms and one or more carbon atoms and may comprise one or more saturated, unsaturated and/or aromatic moieties. Hydrocarbo groups may comprise one or more of the following groups. Hydrocarbyl groups comprise univalent groups formed by removing a hydrogen atom from a hydrocarbon (for example alkyl). Hydrocarbylene groups comprise divalent groups formed by removing two hydrogen atoms from a hydrocarbon, the free valencies of which are not engaged in a double bond (for example alkylene). Hydrocarbylidene groups comprise divalent groups (which may be represented by “R₂C═”) formed by removing two hydrogen atoms from the same carbon atom of a hydrocarbon, the free valencies of which are engaged in a double bond (for example alkylidene). Hydrocarbylidyne groups comprise trivalent groups (which may be represented by “RC≡”), formed by removing three hydrogen atoms from the same carbon atom of a hydrocarbon the free valencies of which are engaged in a triple bond (for example alkylidyne). Hydrocarbo groups may also comprise saturated carbon to carbon single bonds (e.g. in alkyl groups); unsaturated double and/or triple carbon to carbon bonds (e.g. in respectively alkenyl and alkynyl groups); aromatic groups (e.g. in aryl groups) and/or combinations thereof within the same moiety and where indicated may be substituted with other functional groups

The term ‘alkyl’ or its equivalent (e.g. ‘alk’) as used herein may be readily replaced, where appropriate and unless the context clearly indicates otherwise, by terms encompassing any other hydrocarbo group such as those described herein (e.g. comprising double bonds, triple bonds, aromatic moieties (such as respectively alkenyl, alkynyl and/or aryl) and/or combinations thereof (e.g. aralkyl) as well as any multivalent hydrocarbo species linking two or more moieties (such as bivalent hydrocarbylene radicals e.g. alkylene).

Preferred aryl groups herein comprise any aromatic hydrocarbon moiety having 6 to 24 carbon ring atoms which may be monocyclic or annealed. More preferred aryl groups comprise phenyl, and/or radicals from naphthene, azulene, anthracene and/or phenanthrene.

The term heteroaryl denotes any aryl group comprising a ring heteroatom. Preferred hetreoaryl groups comprise any aromatic hydrocarbon moiety having 5 to 24 ring atoms which may be monocyclic or annealed, of which at least one ring atom is a heteroatom selected from the group consisting of N, O, S, and P. More preferred hetreoaryl groups comprise any suitable radicals of pyrrole, indole, imidazole, benzimidazole, pyrazin, pyridazin, triazole, tetrazole, oxazole, isoxazole, thiophene, thiazole, isothiazole, pyridine, chinoline, isochinoline, and/or pyrimidine. Any radical group or moiety mentioned herein (e.g. as a substituent) may be a multivalent or a monovalent radical unless otherwise stated or the context clearly indicates otherwise (e.g. a bivalent hydrocarbylene moiety linking two other moieties). However where indicated herein such monovalent or multivalent groups may still also comprise optional substituents. A group which comprises a chain of three or more atoms signifies a group in which the chain wholly or in part may be linear, branched and/or form a ring (including spiro and/or fused rings). The total number of certain atoms is specified for certain substituents for example C_{1-N}organo, signifies a organo moiety comprising from 1 to N carbon atoms. In any of the formulae herein if one or more substituents are not indicated as attached to any particular atom in a moiety (e.g. on a particular position along a chain and/or ring) the substituent may replace any H and/or may be located at any available position on the moiety which is chemically suitable and/or effective.

Preferably any of the organo groups listed herein comprise from 1 to 36 carbon atoms, more preferably from 1 to 18. It is particularly preferred that the number of carbon atoms in an organo group is from 1 to 12, especially from 1 to 10 inclusive, for example from 1 to 4 carbon atoms.

As used herein chemical terms (other than IUAPC names for specifically identified compounds) which comprise features which are given in parentheses—such as (alkyl)acrylate, (meth)acrylate and/or (co)polymer—denote that that part in parentheses is optional as the context dictates, so for example the term (meth)acrylate denotes both methacrylate and acrylate.

Certain moieties, species, groups, repeat units, compounds, oligomers, polymers, materials, mixtures, compositions and/or formulations which comprise and/or are used in some or all of the invention as described herein may exist as one or more different forms such as any of those in the following non exhaustive list: stereoisomers (such as enantiomers (e.g. E and/or Z forms), diastereoisomers and/or geometric isomers); tautomers (e.g. keto and/or enol forms), conformers, salts, zwitterions, complexes (such as chelates, clathrates, crown compounds, cyptands/cryptades, inclusion compounds, intercalation compounds, interstitial compounds, ligand complexes, organometallic complexes, non-stoichiometric complexes, π-adducts, solvates and/or hydrates); isotopically substituted forms, polymeric configurations [such as homo or copolymers, random, graft and/or block polymers, linear and/or branched polymers (e.g. star and/or side branched), cross-linked and/or networked polymers, polymers obtainable from di and/or tri-valent repeat units, dendrimers, polymers of different tacticity (e.g. isotactic, syndiotactic or atactic polymers)]; polymorphs (such as interstitial forms, crystalline forms and/or amorphous forms), different phases, solid solutions; and/or combinations thereof and/or mixtures thereof where possible. The present invention comprises and/or uses all such forms which are effective as defined herein.

### Activated Unsaturated Moiety

The term “activated unsaturated moiety” “is used herein to denote a species comprising at least one unsaturated carbon to carbon double bond in chemical proximity to at least one activating moiety. Preferably the activating moiety comprises any group which activates an ethylenically unsaturated double bond for addition thereon by a suitable electrophillic group. Conveniently the activating moiety comprises oxy, thio, (optionally organo substituted) amino, thiocarbonyl and/or carbonyl groups (the latter two groups optionally substituted by thio, oxy or (optionally organo substituted) amino). More convenient activating moieties are (thio)ether, (thio)ester and/or (thio)amide moiet(ies). Most convenient “activated unsaturated moieties” comprise an “unsaturated ester moiety” which denotes an organo species comprising one or more “hydrocarbylidenyl(thio)carbonyl(thio)oxy” and/or one or more “hydrocarbylidenyl(thio)carbonyl(organo)amino” groups and/or analogous and/or derived moieties for example moieties comprising (meth)acrylate functionalities and/or derivatives thereof. “Unsaturated ester moieties” may optionally comprise optionally substituted generic α,β-unsaturated acids, esters and/or other derivatives thereof including thio derivatives and analogs thereof.

Preferred activated unsaturated moieties are those represented by Formula 1′.

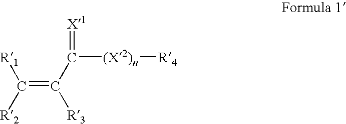

where
n′ is 0 or 1,
X′¹ is oxy or, thio
X′² is oxy, thio or NR′₅ (where R′₅ represents H or optionally substituted organo),
R′₁, R′₂, R′₃ and R′₄ each independently represent H, optionally substituents and/or optionally substituted organo groups; and
all suitable isomers thereof, combinations thereof on the same species and/or mixtures thereof.

In will be appreciated that the terms “activated unsaturated moiety”; “unsaturated ester moiety” and/or Formula 1′ herein may represent a discrete chemical species (such as a compound, ion, free radical, oligomer and/or polymer) and/or any part(s) thereof. Thus Formula 1′ may also represent multivalent (preferably divalent) radicals. Thus the options given herein for n′, X′¹, X′², R′₁₁, R′₂, R′₃, R′₄ and R′₅, also encompass corresponding bi or multivalent radicals as appropriate.

More preferred moieties of Formula 1′ (including isomers and mixtures thereof) are those where n′ is 1; X′¹ is O; X′² is O, S or NR′₅;

R′₁, R′₂, R′₃, and ‘R₄ are independently selected from: H, optional substituents and optionally substituted C₁₋₁₀hydrocarbo, and
where present R′₅ is selected from H and optionally substituted C₁₋₁₀hydrocarbo.

Most preferably n′ is 1, X′¹ is O; X′² is O or S and R′₁, R′₂, R′₃ and R′₄ are independently H, hydroxy and/or optionally substituted C₁₋₄hydrocarbyl.

For example n′ is 1, X′¹ and X′² are both O; and R′₁, R′₂, R′₃ and R′₄ are independently H, OH, and/or C₁₋₄alkyl.

For moieties of Formula 1′ where n′ is 1 and X′¹ and X′² are both O then:

when one of (R′₁ and R′₂) is H and also R′₃ is H, Formula 1′ represents an acrylate moiety, which includes acrylates (when both R′, and R′₂ are H) and derivatives thereof (when either R′₁ or R′₂ is not H). Similarly when one of (R′₁ and R′₂) is H and also R′₃ is CH₃, Formula 1′ represents an methacrylate moiety, which includes methacrylates (when both R′₁ and R′₂ are H) and derivatives thereof (when either R′, or R′₂ is not H). Acrylate and/or methacrylate moieties of Formula 1′ are particularly preferred.

Conveniently moieties of Formula 1′ are those where n′ is 1; X′¹ and X′² are both O; R′₁ and R′₂ are independently H, methyl or OH, and R′₃ is H or CH₃.

More conveniently moieties of Formula 1′ are those where n′ is 1; X′¹ and X′² are both O; R′₁ is OH, R′₂ is CH₃, and R′₃ is H, and/or tautomer(s) thereof (for example of an acetoacetoxy functional species).

Most convenient unsaturated ester moieties are selected from: —OCO—CH═CH₂; —OCO—C(CH₃)═CH₂; acetoacetoxy, —OCOCH═C(CH₃)(OH) and all suitable tautomer(s) thereof.

It will be appreciated that any suitable moieties represented by Formula 1′ could be used in the context of this invention such as other reactive moieties.

### Polymer

The glass transition temperature (T_{g}) of a homopolymer can be determined by conventional methods and in the absence of instructions herein to the contrary all glass transition temperatures herein were measured by differential thermal analysis (DTA) or differential scanning calorimetry (DSC) (see ASTM 3418/82, midpoint temperature).

The T_{g} of the homopolymers of many monomers are known (for example see “Polymer Handbook, 2d Ed. By J. Brandrup & E. H. Immergut, 1975, J. Wiley & Sons”). If a certain monomer is not explicitly listed herein then the T_{g} disclosed in the above handbook should be used to determine whether a certain monomer falls under the definition of any of the constituents. Only where the T_{g} of a distinct homopolymer is not disclosed herein or in the above handbook, will be necessary to obtain the T_{g} from DTA or DSC measurements.

Polymers of the present invention may be prepared by one or more suitable polymer precursor(s) which may be organic and/or inorganic and comprise any suitable (co)monomer(s), (co)polymer(s) [including homopolymer(s)] and mixtures thereof which comprise moieties which are capable of forming a bond with the or each polymer precursor(s) to provide chain extension and/or cross-linking with another of the or each polymer precursor(s) via direct bond(s) as indicated herein.

Polymer precursors of the invention may comprise one or more monomer(s), oligomer(s), polymer(s); mixtures thereof and/or combinations thereof which have suitable polymerisable functionality.

A monomer is a substantially monodisperse compound of a low molecular weight (for example less than one thousand daltons) which is capable of being polymerised. A polymer is a polydisperse mixture of macromolecules of large molecular weight (for example many thousands of daltons) prepared by a polymerisation method, where the macromolecules comprises the multiple repetition of smaller units (which may themselves be monomers, oligomers and/or polymers) and where (unless properties are critically dependent on fine details of the molecular structure) the addition or removal one or a few of the units has a negligible effect on the properties of the macromolecule.

A oligomer is a polydisperse mixture of molecules having an intermediate molecular weight between a monomer and polymer, the molecules comprising a small plurality of monomer units the removal of one or a few of which would significantly vary the properties of the molecule.

Depending on the context the term polymer may or may not encompass oligomer.

The polymer precursor of and/or used in the invention may be prepared by direct synthesis or (if the polymeric precursor is itself polymeric) by polymerisation. If a polymerisable polymer is itself used as a polymer precursor of and/or used in the invention it is preferred that such a polymer precursor has a low polydispersity, more preferably is substantially monodisperse, to minimise the side reactions, number of by products and/or polydispersity in any polymeric material formed from this polymer precursor. The polymer precursor(s) may be substantially un-reactive at normal temperatures and pressures.

Except where indicated herein polymers and/or polymeric polymer precursors of and/or used in the invention can be (co)polymerised by any suitable means of polymerisation well known to those skilled in the art. Examples of suitable methods comprise: thermal initiation; chemical initiation by adding suitable agents; catalysis; and/or initiation using an optional initiator followed by irradiation, for example with electromagnetic radiation (photo-chemical initiation) at a suitable wavelength such as UV; and/or with other types of radiation such as electron beams, alpha particles, neutrons and/or other particles. The substituents on the repeating unit of a polymer and/or oligomer may be selected to improve the compatibility of the materials with the polymers and/or resins in which they may be formulated and/or incorporated for the uses described herein. Thus the size and length of the substituents may be selected to optimise the physical entanglement or interlocation with the resin or they may or may not comprise other reactive entities capable of chemically reacting and/or cross-linking with such other resins as appropriate.

### Process

The invention also relates to the preparation of aqueous polymer dispersions containing Polymer P.

Polymer P of the invention is preferably obtained by emulsion polymerization. The emulsion polymerization is preferably carried out at a temperature of from about 30° to about 100° C., more preferably from about 50° to about 95° C. The polymerization medium may consist exclusively of water, but also mixtures of solvents which are at least partially soluble in water may be used, e.g. a mixture of methanol and water or a mixture of isopropanol and water. The emulsion polymerization may be carried out in a batch process or alternatively in a semi-continuous process, wherein the reactants and auxiliary additives are added continuously to a reactor in which the polymerization takes place. The reactants may be added as a gradient or stepwise.

In a preferred embodiment of the process according to the invention the polymerization is carried out in a semi-continuous process, wherein initially a relatively small portion of the monomers to be polymerized may be fed into the reactor, heated and pre-polymerized. Then, the remainder of the monomers is continuously fed into the reactor, usually via several inlets which are spatially separated from one another. The monomers may be fed into the reactor in pure or in emulsified form (pre-emulsions), as single monomers per inlet or as mixtures of monomers. The mass flow through each inlet may be adjusted individually, i.e. stepwise or as a gradient. The monomers may also be fed into the reactor, thereby establishing a superimposed concentration gradient within the reaction zone of the reactor.

In another preferred embodiment of the process according to the invention the polymerization is carried out in a semi-continuous process, wherein the polymerization starts with a polymerized seed or with a pre-polymer. The chemical nature of the polymerized seed or the pre-polymer is not limited, as long as the polymers P which are finally obtained from the polymerization, are covered by the definition of polymers P. Not all of the constituents have to be present simultaneously in the polymerized seed or in the pre-polymer. Preferably the composition of the constituents of the polymerized seed and the composition of the constituents which are polymerized on the polymerized seed differ in at least one constituent. Preferably the aqueous dispersion contains as a polymerized seed or a pre-polymer a polymer having a non-zero weight average diameter of from about 10 to about 100 nm, preferably of from about 40 to about 60 nm.

Preferably Polymer P is prepared by emulsion polymerization in water in the presence of suitable surfactants. Preferably the final aqueous polymer dispersion obtained from the polymerization process contains from about 1% to about 5% by weight of surfactants (based on the total weight of the monomers to be polymerized). Suitable surface active substances include not only the protective colloids customarily used for carrying out free radical aqueous emulsion polymerizations but also emulsifiers.

Examples of suitable protective colloids are polyvinyl alcohols, cellulose derivatives and vinylpyrrolidone-containing polymers. A detailed description of further suitable protective colloids may be found in Houben-Weyl, Methoden der organischen Chemie, Volume XIV/1, Makromolekulare Stoffe, Georg Thieme Verlag, Stuttgart, 1961, pages 411 to 420.

It is also possible to use mixtures of emulsifiers and/or protective colloids. Preferably, the surface active substances used are exclusively emulsifiers whose relative molecular weights are customarily below 2000, in contrast to protective colloids. They can be anionic, cationic or non-ionic in nature. If mixtures of surface active substances are used, the individual components must be compatible with one another, which can be verified in advance of the polymerization by means of a few preliminary experiments if there is any doubt. In general, anionic emulsifiers are compatible with one another and with non-ionic emulsifiers. The same is true of cationic emulsifiers, while anionic and cationic emulsifiers are usually incompatible with one another. Suitable surfactants for use in the invention will be well known to those skilled in the art and/or are described separately below.

Preferably the aqueous polymer dispersions according to the invention are the product dispersions which are directly obtained from the emulsion polymerization. These aqueous polymer dispersions may be used as such for different purposes, for example as pressure sensitive adhesives (PSA). PSAs of the invention may be applied to any suitable surface or substrate such as to a polymeric film for example used as facestock for labels.

### Surfactants/Emulisfiers

According to the invention the emulsifiers are divided into two groups: emulsifiers containing aromatic groups (aromatic emulsifiers) and emulsifiers not containing any aromatic groups (aliphatic emulsifiers). In this specification the simple term “emulsifier” encompasses both, aromatic emulsifiers and aliphatic emulsifiers.

Preferred aliphatic emulsifiers are ethoxylated fatty alcohols (such as those with EO degree from about 3 to about 50 and comprising C₈₋₃₆alkyl group(s)), alkali metal and/or ammonium salts of alkyl sulfates (such as those comprising C₈₋₁₂alkyl group(s)), alkali metal and/or ammonium salts of sulfuric monoesters of ethoxylated alkanols (such as those with EO degree from about 4 to about 30 and comprising C₁₂₋₁₈alkyl group(s)), alkali metal and/or ammonium salts of alkylsulfonic acids (such as those comprising C₁₂₋₁₈alkyl group(s)); and/or suitable mixtures thereof.

Preferred aromatic emulsifiers are ethoxylated mono-, di- and trialkylphenols (such as those with EO degree from about 3 to about 50 and comprising C₄₋₉alkyl group(s)), ethoxylated alkylphenols (such as those with EO degree from about 3 to about 50 and comprising C₄₋₉alkyl group(s)), alkali metal and ammonium salts of alkylarylsulfonic acids (such as those comprising C₉₋₁₁alkyl group(s)), sulfonated alkylarylethers; alkali metal and ammonium salts of polyaryl phenyl ether sulfates and/or mixtures thereof.

Further suitable aromatic and aliphatic emulsifiers may be found in Houben-Weyl, Methoden der organischen Chemie, Volume XIV/1, Makromolekulare Stoffe, Georg Thieme Verlag, Stuttgart, 1961, pages 192 to 208.

Advantageously the surfactant used in the present invention may be an ionic surfactant that comprises

(I) a plurality, preferably at least three, aromatic rings,
(II) at least one electronegative substituent formed from a strong acid, optionally selected from a mono valent oxy substituted sulfo anion, and/or a mono valent oxy substituted phospho anion, and
(III) optionally at least one substituent comprising multiple hetero-organo units, optionally one or more repeating oxyhydrocarbylene units which may be the same or different.

Optionally the above ionic surfactants may be used alone or in combination with other surfactants types (either ionic or non ionic).

More advantageously the ionic surfactant may be aromatic and have an HLB value from about 8 to about 20, preferably from about 10 to about 18, more preferably from about 12 to about 17, for example about 16.

Conveniently the aromatic ionic surfactant is represented by Formula A

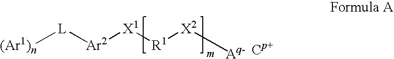

where Ar¹ and Ar² independently in each case each represent C₆₋₁₈hydrocarbo comprising an aromatic moiety,
L is a divalent organo linking group or direct bond, where optionally Ar¹ and Ar² may together form a fused ring;
R¹ is an optionally substituted C₁₋₈hydrocarbylene, more preferably C₁₋₆alkylene;
X¹ and X² independently in each case each represent O, S, CH₂, NH or NR³ where R³ represents optionally substituted C₁₋₂₀hydrocarbyl, more preferably C₁₋₁₀alkyl;
A represents a S(O)₁₋₃ or P(O)₁₋₃ moiety and q is from 1 to 3;
C is a suitable counter cation and p balances the charge q;
m represents an integer from 1 to 70, preferably from 5 to 60; more preferably from 10 to 50; most preferably from 10 to 30 for example about 16;
n represents an integer 1 to 6, optionally 1 to 3.

More conveniently the ionic surfactant of Formula I is represented by Formula B

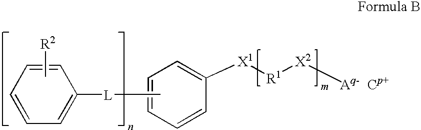

where L, R¹, X¹, X², A, C, q, p, n and m are as given for Formula A, and R² is an optionally substituted C₁₋₈hydrocarbylene, more preferably C₁₋₆alkylene.

More preferably in Formula B

L, R¹ and R² are independently in each case C₁₋₄alkylene, more preferably —CHCH₂(CH₃)—, —CH(CH₃)— or —CH₂CH₂—,
X¹ and X² independently in each case O, S, NH or —N(C₁₋₆alkyl)-, most preferably O,

### A is a S(O)₃ or P(O)₃ and q is 1

C is a suitable counter cation and optionally p is 1;
n is from 1 to 3 more preferably 3, and m is from 10 to 30, most preferably 10 to 20 for example 16.

Most preferred surfactants of Formulae A and B are those that are obtained and/or obtainable by the reaction of styrene and phenol followed by phosphation and/or sulfation of the resultant alkoxylated multiply styryl substituted phenol (such as tristryryl phenol and/or derivatives thereof).

Particularly preferred tristryryl phenol ionic surfactants of Formulae A and B are those available from Rhodia under the following trade designations:

Soprophor 3D-33 (an ethoxylated phosphate ester free acid);
Soprophor 3D-33/LN (a low non ionic ethoxylated phosphate ester free acid);
Soprophor 3D-FLK (an ethoxylated phosphate ester potassium salt);
Soprophor 3D-FL (an ethoxylated phosphate TEA (triethylamine) salt);
Soprophor 3D-FL-60 (an ethoxylated phosphate TEA (triethylamine) salt);
Soprophor 4D-384 (an ethoxylated sulfate, ammonium salt);
Soprophor 4D-360 (an ethoxylated sulfate, ammonium salt); and/or any suitable mixtures thereof.

An exemplified surfactant may be represented by

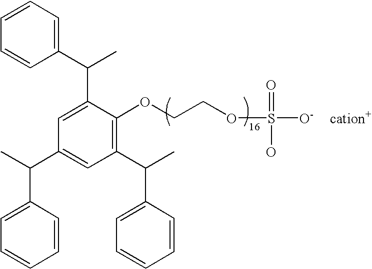

which (when the cation is ammonium) is available from Rhodia under the trade designation Soprophor 4D384.

In an alternative embodiment of the invention optionally substituted derivatives of alkylene naphthyl sulfonate available commercially from King Industries may be used as the ionic surfactant.

### Chain Transfer Agents

Preferred Polymers P are obtained and/or are obtainable by polymerisation of each of the constituents ‘a’, ‘b’ and ‘c’ and optionally constituent ‘d’ in the presence of at least one suitable chain transfer agent(s) in a total amount of less than about 0.05% optionally less than about 0.03% by weight of the total monomer composition;

Chain transfer agents (CTAs) can also be used in the course of the polymerization, but in one embodiment substantially no CTA is used to prepare the polymers of the present invention. If any CTA is used it is preferred to be used in as low amount as possible, conveniently up to 0.05 parts by weight, more conveniently from about 0.01 to about 0.05 part by weight, and most conveniently from about 0.01 to about 0.03 parts by weight per 100 parts per weight of the monomers to be polymerized. The function of the chain transfer agents is to reduce the molar mass of the polymers obtained. Suitable CTAs comprise compounds having a thiol group, such as tert-butyl mercaptane, ethylhexyl thioglycolate, mercaptoethanol, mercaptopropyl-trimethoxysilane, n-dodecyl mercaptane and/or tert-dodecyl mercaptane.

Suitable initiators have been described previously.

The suitable mode of supplying the reaction medium with initiator is known to the skilled person. Before the polymerization starts the initiator may be present in the reactor either in the total amount or only in part. In the latter case, the remainder of the initiator is fed into the reactor via an inlet at a rate dependent on the consumption of the initiator due to the polymerization reaction. In order to avoid that any monomers are still present in the reaction medium after the polymerization has come to an end, generally further initiator is added when the yield of the reaction is in the range of about 95% or above.

Monomers, initiators, chain transfer agents, etc. may be fed into the reactor from the top, at the side or through the bottom of the reactor.

The emulsion polymerization usually yields aqueous polymer dispersions having a solids content of from about 15% to about 75%, preferably of from about 50% to about 75% by weight. Polymer dispersions having high solids content are preferred.

Preferably, Polymer P obtained and/or obtainable according to the invention has an average particle size of from about 200 to about 280 nm. The pH of the aqueous dispersions is preferably in the range of from about 4 to about 9.

Polymer P, particularly aqueous polymer dispersions thereof; may be used as adhesives, preferably as pressure sensitive adhesives. Preferably Polymer P is used in form of aqueous dispersions, which may be used without addition of any further additives. However, it is also possible that further additives, such as tackifiers, defoaming agents, thickening agents, coagulants, softeners, pigments, surfactants, biocides or fillers are added.

Examples of suitable tackifiers are resins such as kolophonium resins (e.g. abientinic acid) and their derivatives, such as esters thereof. Kolophonium esters may be obtained from alcohols such as methanol, ethandiol, diethylene glycol, triethylene glycol, 1,2,3-propanetriol, pentaerythritol, etc. Other suitable tackifiers are cumaron-inden resins, polyterpene resins, hydrocarbon resins based on unsaturated hydrocarbons, such as butadiene, pentene, methylbutene, isoprene, piperylene, divinylmethane, pentadiene, cyclopentene, cyclopentadiene, cyclohexadiene, styrene and styrene derivatives. Further suitable tackifiers are polyacrylates having a relatively low molecular weight (mean average weight generally below 30000). Preferred polyacrylates comprise one or more C₁₋₈alkyl(meth)acrylate(s).

The terms ‘effective’, ‘acceptable’ ‘active’ and/or ‘suitable’ (for example with reference to any process, use, method, application, preparation, product, material, formulation, compound, monomer, oligomer, polymer precursor, and/or polymers of the present invention and/or described herein as appropriate) will be understood to refer to those features of the invention which if used in the correct manner provide the required properties to that which they are added and/or incorporated to be of utility as described herein. Such utility may be direct for example where a material has the required properties for the aforementioned uses and/or indirect for example where a material has use as a synthetic intermediate and/or diagnostic tool in preparing other materials of direct utility. As used herein these terms also denote that a functional group is compatible with producing effective, acceptable, active and/or suitable end products.

Preferred utility of the present invention comprises use as a pressure sensitive adhesive more preferably which exhibits improved resistance to plasticizer.

Further aspects and preferred embodiments of the invention are given in the claims.

The invention is further illustrated by the following non-limiting examples:

Various registered trademarks, other designations and/or abbreviations are used herein to denote some of ingredients used to prepare polymers and compositions of the invention. These are identified in the table below by chemical name and/or trade-name and optionally their manufacturer or supplier from whom they are available commercially. However where a chemical name and/or supplier of a material described herein is not given it may easily be found, e.g. in “McCutcheon's Emulsifiers and Detergents”, Rock Road, Glen Rock, N.J. 07452-1700, USA, 1997 and/or Hawley's Condensed Chemical Dictionary (14th Edition) by Lewis, Richard J., Sr.; John Wiley & Sons.

“AA” denotes acrylic acid (CH₂═CHCO₂H).

“Abex 3594” is an anionic surfactant blend from Rhodia.

“Acticide MV14” is the trade name of a biocide from Thor GmbH which contains the active ingredients 2-Methyl-3(2H)-isothiazolone (3.5%) and 5-chloro-2-methyl-3(2H)-isothiazolone (10.6%)

“Acticide L30” “is the trade name of a biocide from Thor GmbH which contains the active ingredient 2-bromo-2-nitropropane-1,3-diol (30%).

“Acticide MBS” is the trade name of a biocide from Thor GmbH which contains the active ingredients 2-methyl-2H-isothiazolin-3-one 1,2-benzisothiazolin-3(2H)-one.

“Aerosol® OT 75” (also denoted “AOT” herein) is the trade mark of an anionic surfactant available commercially from Sigma Chemical

“Alcogum 296-W” is the trade designation of a high viscosity aqueous solution of sodium polyacrylate available commercialy from Alco Chemical

“AMP-95” is the trade designation of a primary amino alcohol dispersant from Dow.

“BA” denotes butyl acrylate

“EA” denotes ethyl acrylate.

“Ebecryl 110”® is a trade mark of Cytec denoting a monoacrylate of ethoxylated phenol

“Ebecryl 114”® is a trade mark of Cytec denoting a phenoxy ethyl acrylate

“EHA” denotes 2-ethyl hydroxy acrylate

“Formopon” is the trade designation of sodium formaldehyde hydrosulfite (also denoted

SFS herein) commercially available from Rohm & Haas

“HBA” denotes hydroxy butyl acrylate

“HDDA” denotes hexane diol diacrylate

“KPS” denotes potassium persulfate.

“NaPS” denotes sodium persulfate.

“MA” denotes methyl acrylate.

“MAA” denotes methacrylic acid (CH₂═C(CH₃)CO₂H).

“MMA” denotes methyl methacrylate

“Norsocryl® 102” (also denoted “N102” herein) is a monomer which is a solution of 2-(2-oxoimidazolidin-1-yl)ethyl methacrylate (MEIO) in methyl methacrylate (MMA, 75% by weight) that is available under that trade name from Arkema

“Rhodaline 962” is the trade designation of a hydrophobic dispersant from Rhobia

“Rongalit C®” is the trade name of a polymerisation initiator which is sodium hydroxymethanesulfinate (BASF).

“Soprophor® 4D384” is a surfactant which is the ammonium salt of tristyrylphenol-16 EO sulfate that is available under that trade name from Rhodia.

“Surfynol 440” and “Surfynol 420 are trade designations of non-ionic ethoxylated surfactant/defoamer from Air Products

“t-BHP” denotes tert. butyl hydroxy peroxide commercially available for example as 70% tBHP in 30% water under the trade designations Luperox H70 or Trigonox A-W70 (respectively from Arkema or AkzoNobel)

Two polymers, the composition of which is shown in Tables 1a and 2a here below, were prepared. Comp A is a comparative example with low initiator content, Example 1 is a polymer P according to the invention:

TABLE 1a

| | | |
|---|---|---|
| Comp A | [g] | [wt.-%] |

Monomers

| | | | |
|---|---|---|---|
| a | n-butyl acrylate | 807.98 | 67.67 |
| b | methyl methacrylate | 358.20 | 30.00 |
| c | acrylic acid | 11.94 | 1.00 |
| d | Hexane diol diacrylate (HDDA) | 0.96 | 0.08 |
| d | Norsocryl 102 | 14.93 | 1.25 |
| | Σ | 1194.01 | 100.00 |

Initiators

| | | |
|---|---|---|
| Sodium persulfate | 3.6 | 0.30 |

TABLE 2a
Example 1

| | |
|---|---|
| [g] | [wt. %] |

Monomers

| | | | |
|---|---|---|---|
| a | n-butyl acrylate | 807.98 | 67.67 |
| b | methyl methacrylate | 358.20 | 30.00 |
| c | acrylic acid | 11.94 | 1.00 |
| d | Hexane diol diacrylate (HDDA) | 0.96 | 0.08 |
| d | Norsocryl 102 | 14.93 | 1.25 |
| | Σ | 1194.01 | 100.00 |

Initiators

| | | |
|---|---|---|
| Sodium persulfate | 7.2 | 0.60 |

The polymers were polymerized in a reactor at a polymerization temperature of 82° C. in a conventional manner well known to those skilled in the art. During the course of the polymerization one monomer pre-emulsion was fed into the reactor. In parallel, the initiator solution (in pre-mix tank 2) is fed into the reactor. The initial composition of the pre-emulsions and the initial reactor content are shown in the Tables 1b and 2b:

TABLE 1b
Comp A

| | | | Weight [g] | |
|---|---|---|---|---|
| | | | Bottom | Pre- |
| Steps | Raw Materials | Dilution | tank | emulsion |
| Reactor | H₂O | | 446.00 | |
| | polymerized seed | 33% | 18.18 | |
| Initiator | Na₂S₂O₈ | | 1.20 | |
| | H₂O | | 14.40 | |
| Pre-mix tank 2 | Na₂S₂O₈ | | 2.40 | |
| | H₂O | | 25.60 | |
| Pre-emulsion | H₂O | | | 301.89 |
| In pre-mix tank 1 | NaHCO₃ | | | 3.24 |
| | Soprophor 4D 384 | | | 24.00 |
| | n-butyl acrylate | | | 807.98 |
| | methyl methacrylate | | | 358.20 |
| | acylic acid | | | 11.94 |
| | HDDA | | | 0.96 |
| | Norsocryl 102 | | | 14.93 |
| Monomer | Fe(NO₃)₃ | 10% | 0.05 | |
| Chasing | Luperox H70 | 10% | 6.00 | |
| | Rongalit C | 5% | 12.00 | |
| Formulation | Acticide MBS | 1% | 4.50 | |

### EXAMPLE 1

described in Table 2b is prepared and treated in the same manner as Comp A given in Table 1b.

TABLE 2b
Example 1

| | | | Weight [g] | |
|---|---|---|---|---|
| | | | Bottom | Pre- |
| Steps | Raw Materials | Dilution | tank | emulsion |
| Reactor | H₂O | | 446.00 | |
| | polymerized seed | 33% | 18.18 | |
| Initiator | Na₂S₂O₈ | | 1.20 | |
| | H₂O | | 14.40 | |
| Pre-mix tank 2 | Na₂S₂O₈ | | 6.00 | |
| | H₂O | | 54.00 | |
| Pre-emulsion in | H₂O | | | 279.49 |
| pre-mix tank 1 | NaHCO₃ | | | 3.24 |
| | Soprophor 4D 384 | | | 24.00 |
| | n-butyl acrylate | | | 807.98 |
| | methyl methacrylate | | | 358.20 |
| | acylic acid | | | 11.94 |
| | HDDA | | | 0.96 |
| | Norsocryl 102 | | | 14.93 |
| Monomer | Fe(NO₃)₃ | 10% | 0.05 | |
| Chasing | Luperox H70 | 10% | 6.00 | |
| | Rongalit C | 5% | 12.00 | |
| Formulation | Acticide MBS | 1% | 4.50 | |

The polymerized seed used in these syntheses is based on the following monomer composition: styrene (15.5 wt %), n-butyl acrylate (83 wt %) and acrylic acid (1.5 wt %):

TABLE 3
Polymerized seed

| | | | Weight [g] | |
|---|---|---|---|---|
| | | | Bottom | Pre- |
| Steps | Raw Materials | Dilution | tank | emulsion |
| Reactor | H₂O | | 1615.00 | |
| | Abex 3594 | 36% | 69.44 | |
| Initiator | (NH₄)₂S₂O₈ | 10% | 20.00 | |
| Pre-mix tank 2 | (NH₄)₂S₂O₈ | 10% | 20.00 | |
| Pre-emulsion in | H₂O | | | 403.00 |
| pre-mix tank 1 | Abex 3594 | | | 13.9 |
| | n-butyl acrylate | | | 830.00 |
| | styrene | | | 155.00 |
| | acylic acid | | | 1.50 |

To make the polymerised seed, the reactor was fed with water and surfactant, then heated to 82° C. Then, initiator is introduced and the monomer pre-emulsion was fed into the reactor over 3 to 4 hours. In parallel, the initiator solution (in pre-mix tank 2) was fed into the reactor. The mixture was aged for 1 hour then cooled.

The adhesive properties of the aqueous polymer dispersions obtained from Comp A and Example 1 were tested according to standard test methods such as those described herein.

Polymers shown in Examples 2 and 3 below were prepared similarly to Example 1 and formulated into respective PSAs Examples 4 and 5

### EXAMPLE 2

Polymer composition (+biocide)

| | weight (lbs) | weight % |
|---|---|---|
| deionized water | 11067.0 | 37.31 |
| sodium bicarbonate | 46.0 | 0.16 |
| sodium persulfate | 104.0 | 0.35 |
| Soprophor 4D384 (25%) | 1364.0 | 4.60 |
| hexanediol diacrylate | 13.7 | 0.046 |
| Norsocryl 102 | 213.0 | 0.72 |
| acrylic acid | 170.0 | 0.57 |
| methyl acrylate | 2556.0 | 8.62 |
| methyl methacrylate | 2556.0 | 8.62 |
| butyl acrylate | 11531.0 | 38.88 |
| ferrous sulfate heptahydrate | 0.048 | 0.00016 |
| Trigonox A-W70 | 12.20 | 0.0411 |
| Formopon | 8.50 | 0.0287 |
| Acticide MV14 | 10.40 | 0.0351 |
| Acticide L30 | 9.70 | 0.0327 |
| Total | 29661.548 | 100.000 |

### EXAMPLE 3

Polymer composition (+biocide)

| | weight (lbs) | weight % |
|---|---|---|
| deionized water | 175.251 | 31.864 |
| sodium bicarbonate | 0.931 | 0.169 |
| sodium persulfate | 1.843 | 0.335 |
| Soprophor 4D384 (25%) | 27.486 | 4.997 |
| hexanediol diacrylate | 0.270 | 0.049 |
| Norsocryl 102 | 4.224 | 0.768 |
| acrylic acid | 3.381 | 0.615 |
| methyl methacrylate | 100.540 | 18.280 |
| butyl acrylate | 235.220 | 42.767 |
| ferrous sulfate heptahydrate | 0.00090 | 0.00016 |
| Trigonox A-W70 | 0.259 | 0.047 |
| Formopon | 0.215 | 0.039 |
| Acticide MV14 | 0.197 | 0.036 |
| Acticide L30 | 0.183 | 0.033 |
| Total | 550.001 | 100.000 |

### EXAMPLE 4

PSA formulation with polymer of Example 2

| | pph | weight ratio |
|---|---|---|
| Example 2 | 100.000 | 29202.76 |
| Aerosol OT 75 | 0.280 | 81.77 |
| Surfynol 440 | 0.600 | 175.22 |
| Rhodaline 962 | 0.100 | 29.20 |
| ammonia (28%) | 0.180 | 52.56 |
| de-ionised water | 1.570 | 458.48 |
| Total | 102.73 | 30000.00 |

### EXAMPLE 5

PSA formulation with polymer of Example 3

| | pph | wt % |
|---|---|---|
| Example 3 | 100.000 | 98.386 |
| AMP-95 | 0.420 | 0.413 |
| Aerosol OT 75 | 0.300 | 0.295 |
| Rhodoline 962 | 0.200 | 0.197 |
| Alcogum 296-W | 0.720 | 0.708 |
| Total | | 100.00 |

Test methods

Peel adhesion (peel strength) was determined according to FINAT test methods (FTM) Nos. 1. This standard test method FTM 1 is described in FINAT Technical Handbook 5^{th} edition, 1999, (published by FINAT, P.O. Box 85612 NL-2508 CH The Hague, The Netherlands).

### a) Preparing the Test Strips

The test dispersion was mixed with ammonia (to reach pH=7) and with a wetting agent (i.e. Surfynol 420 (from Air products)). The mixture proportion was 0.6 g Surfynol in 100 g latex. Then, it was applied to siliconized paper in a thin film, using a bar coater, and was dried at 110° C. for 3 minutes. The gap height of the coating bar was chosen so that the weight per unit area of the dried adhesives was about 25 g/m². A commercially customary DOP-plasticized PVC film (80 μm thick) was placed on the dried adhesive and rolled on firmly using a manual roll. The resulting adhesive was stored under atmospheric conditions for at least 24 h, then it was cut into 25 mm wide strips. Their minimum length was 175 mm.

### b) Testing the Peel Strength as a Measure of the Adhesion (According to FINAT FTM 1)

After the siliconized paper had been peeled off, the film test strip was bonded to a glass plate (ambient conditions: 23° C., 50% relative humidity). The test strip was leaved for 20 min, then the strip was peeled off at an angle of 180° and at a rate of 300 mm/min with the aid of a tensile testing apparatus. The peel strength was taken as the force, in N/25 mm, required to do this, again as a mean from the results of three test specimens.

### c) Testing the Peel Retention

The peel strength test procedure was repeated with a second set of strips which was first placed in an oven at 80° C. for 2 days. Then, before peeling off the siliconized paper, test strips were allowed to equilibrate for 4 hours at 23° C./50% RH (RH is relative humidity)

### d) Testing the Shrinkage Resistance

### (d) (i) Preparation of the Coated Material

The test dispersion was mixed with ammonia (to reach pH=7) and with a wetting agent (i.e. Surfynol 420 (from Air products)). The mixture proportion was 0.6 g Surfynol in 100 g latex. Then, it was applied to siliconised paper in a thin film, using a bar coater, and was dried at 110° C. for 3 minutes. The gap height of the coating bar was chosen so that the weight per unit area of the dried adhesives was about 25 g/m². A commercially customary DOP-plasticized PVC film (80 μm thick) was placed on the dried adhesive and rolled on firmly using a manual roll. The resulting adhesive was stored under atmospheric conditions for at least 24 h, then it was cut into 50 mm wide strips. Their length was 200 mm.

### (d) (ii) Measurement of Samples

After the siliconised paper had been peeled off, the film test strip was bonded to a glass plate (ambient conditions: 23° C., 50% relative humidity). To ensure a controlled contact between the adhesive and the glass substrate a 2 kg roller was passed four times (=two return journeys) over the strip. The test strip was then cut in 2 pieces of equal length parallel to the shortest side of the strip. Afterwards, the strip was left for 7 days in an oven at 70° C. After being taken out of the oven, the width of the split between the two pieces of the test strip was measured and reported in millimeters (mm).

TABLE 4

| | Comp A | Example 1 |
|---|---|---|
| solid content [wt.-%]¹ | 59.74 | 59.89 |
| Brookfield viscosity 50 rpm (cps)¹ | 400 | 320 |
| pH¹ | 4.79 | 2.58 |
| particle size [nm]^{1,2} | 265 | 266 |
| peel strength 20 min [N/25 mm] | 11.8 | 15.2 |
| peel strength 20 min [N/25 mm] | 1.15 | 5.0 |
| after ageing 2 days at 80° C.³ | | |
| Shrinkage [mm] | 0.3 | 0.4 |

Note
¹Mean value from results of three measurements
²Weight-averaged values were determined by dynamic light scattering (Ni comp 370, Particle Sizing Systems).
³The testing strips were aged for 7 days at 70° C. in an oven as described earlier.

As illustrated by the above data, Example 1, a PSA according to the invention, exhibited both improved peel retention and excellent shrinkage resistance compared to the comparative example Comp A.

### EXAMPLES 6 to 18

Various other polymers were prepared in a similar manner to Example 2 as described below. These polymers may also be formulated into PSAs as described herein.

Main Monomer Compatible with Migrating Plasticizer:

### EXAMPLE 6

Prepared as described in Example 2 except the butyl acrylate monomer was replaced by an equal weight of 2-ethyl acrylate monomer

### EXAMPLE 7

Prepared as described in Example 2 except the butyl acrylate monomer was replaced an equal weight of a blend of 2-ethyl acrylate and butyl acrylate monomers in a 50:50 weight ratio.

### Carboxylated Monomers:

### EXAMPLE 8

Prepared as described in Example 2 except the acrylic acid (AA) monomer was replaced by an equal weight (1%) of methacrylic acid (MAA).

### EXAMPLE 9

Prepared as described in Example 2 except the acrylic acid (AA) monomer was replaced by an increased amount (2% by weight) of methacrylic acid (MAA).

### EXAMPLE 10

Prepared as described in Example 2 except the amount of acrylic acid (AA) monomer was increased from 1% to 2% by weight.

### Cross-Linking Reaction

### EXAMPLE 11

Prepared as described in Example 2 with 0.35 g formaldehyde added at end of monomer pre-emulsion feeding to enhance cross-linking reaction with Norsocryl 102

### Other Functional Monomers to Increase Anchorage of PSA on PVC

### EXAMPLE 12

Prepared as described in Example 2 except the methyl methacrylate (MMA) was replaced an equal weight (5%) of the monoacrylate of ethoxylated phenol available commercially from Cytec under the trade mark “Ebecryl 110”

### EXAMPLE 13

Prepared as described in Example 2 except the methyl methacrylate (MMA) was replaced an equal weight (5%) of the phenoxy ethyl acrylate available commercially from Cytec under the trade mark “Ebecryl 114”

### EXAMPLE 14

Prepared as described in Example 2 except the butyl acrylate monomer (BA) was replaced by an equal weight (3%) of hydroxy butyl acrylate (HBA).

Without being bound by any mechanism Examples 12 to 14 were prepared because it is believed that hydroxy functionalised monomers post-react very easily with the Norsocryl 102 type functional monomers.

### Initiator Content to Influence on Molecular Weight Distribution

### EXAMPLE 15

Prepared as described in Example 2 except the amount of initiator used was reduced to 0.4% by weight (from 0.61%)

### EXAMPLE 16

Prepared as described in Example 2 except the amount of initiator used was reduced to 0.5% by weight (from 0.61%)

### OTHER EXAMPLES

### EXAMPLE 17

A polymer of the invention may be prepared as described in Example 6 except the acrylic acid monomer is replaced by an equal weight of methacrylic acid

### EXAMPLE 18

A polymer of the invention may be prepared as described in Example 6 except the acrylic acid monomer is replaced by an equal weight of methacrylic acid and 0.4% by weight of NaPS is added.

The above examples were formulated as PSA as described herein. Test strips where prepared and removed from test plates in the test method described herein.

### Results

The peel values measured (2 strips) for some of the Examples with no/very limited transfer are given in the following table:

| | Ex 6 | Ex 15 | Ex 8 | Ex 9 |
|---|---|---|---|---|
| Coatweight (g/m²) | 25 | 25 | 25 | 25 |
| Peel (180°, stainless steel plate, | 15.7 | 24.2 | 23.6 | 25.2 |
| 7 d@70° C.) (N/inch) | | | | |

It was found particular embodiments of the invention are particularly preferred as they particularly enhanced the removability of the PSA coated test strip (less residual adhesive left on the plate).

Examples 6, 8 and 9 obtained results comparable to prior art solvent-base adhesives as there was nearly no residue left after peeling.

Modifications observed from these tests to provide particularly enhanced removability of adhesive included:

replacing BA by 2EHA (Example 2 compared to Example 6)
replacing AA by MAA (Example 2 compared to Example 8)
increasing the amount of carboxylated monomer (e.g. AA) (Example 2 compared to Example 10); and
increasing the amount of cross-linking with a functional monomer (such as Norsocryl 102) (Example 2 compared to Example 11).

Such modifications either alone or in combination are therefore preferred embodiments of the present invention.

1. A polymer (Polymer P) which is obtained and/or is obtainable from a monomer composition comprising:
(a) from about 5% to about 95% by weight of at least one C₂₋₁₂alkyl acrylate (constituent a);
(b) from about 2.5% to about 60% by weight of at least one polymer precursor selected from the group consisting of: C₁₋₃₀ alkyl(meth)acrylates, C₂₋₃₀ vinyl aromatic compounds, C₂₋₃₀ vinyl halides, C₂₋₃₀ vinyl nitrites, C₂₋₃₀ vinyl esters of carboxylic acids and mixtures thereof; with the provisos that
(i) the homopolymers of each of said polymer precursor(s) have a T_{g} above about −25° C.; and
(ii) each of said polymer precursor(s) comprises other than a functional group selected from the group consisting of: hydroxy, carboxy, acid anhydride, nitro, epoxy and amino (constituent b);
(c) from about 0.1% to about 2% by weight of at least one polymer precursor comprising at least one activated unsaturated moiety having at least one carboxy and/or acid anhydride group(s) (constituent c); and
(d) optionally up to about 60% by weight of at least one further optionally substituted polymer precursor comprising at least one activated unsaturated moiety, where the further optional substituent(s) are other than carboxy and/or an acid anhydride group(s) (constituent d).
where each of the constituents ‘a’, ‘b’ and ‘c’ and optionally constituent ‘d’ are different from each other
with the additional proviso that Polymer P was obtained and/or is obtainable by polymerisation of the each of the constituents ‘a’, ‘b’ and ‘c’ and optionally constituent ‘d’ in the presence of a water soluble initiator in an amount above about 0.35% by weight of the total monomer composition.

2. The polymer according to claim 1, with the further proviso that Polymer P was obtained and/or is obtainable by polymerisation of each of the constituents ‘a’, ‘b’ and ‘c’ and optionally constituent ‘d’ in the presence of at least one suitable chain transfer agent(s) in a total amount of less than about 0.05% by weight of the total monomer composition;

3. The polymer according to claim 1, with the further proviso that Polymer P was obtained and/or is obtainable by polymerisation of each of the constituents ‘a’, ‘b’ and ‘c’ and optionally constituent ‘d’ in the substantial absence of any chain transfer agent.

4. The polymer according to claim 1, where constituent ‘a’ comprises at least one alkyl acrylate selected from the group consisting of n-butyl acrylate, 2-ethylbutyl acrylate, hexyl acrylate, 2-ethylhexyl acrylate, nonyl acrylate and n-octyl acrylate.

5. The polymer according to claim 1, where constituent ‘b’ comprises at least one C₁₋₃₀ alkyl(meth)acrylate.

6. The polymer according to claim 5, where constituent ‘b’ comprises at least one alkyl(meth)acrylate selected from the group consisting of ethyl acrylate, sec-butyl acrylate, dodecyl acrylate, isobutyl acrylate, methyl acrylate, n-butyl methacrylate, methyl methacrylate, tert-butyl acrylate and isopropyl acrylate.

7. The polymer according to claim 1, where constituent ‘c’ comprises at least one ethylenically unsaturated monomer selected from the group consisting of (meth)acrylic acid, maleic acid, maleic acid anhydride, maleic acid monoester and fumaric acid monoester.

8. The polymer according to claim 1, where constituent ‘d’ comprises at least one ethylenically unsaturated compound having a group selected from the group consisting of epoxy groups, hydroxyl groups, ethyl imidazolidone groups, N-methylol groups, carbonyl groups and further ethylenically unsaturated groups which are not conjugated with the other ethylenically unsaturated group(s).

9. An aqueous dispersion of particles of a Polymer P as claimed in claim 1.

10. The dispersion as claimed claim 9 which comprises at least one aromatic emulsifier

11. A dispersion as claimed claim 10, in which the aromatic emulsifier is an ionic surfactant that comprises
(I) a plurality of aromatic rings,
(II) at least one electronegative substituent formed from a strong acid, optionally selected from a mono valent oxy substituted sulfo anion, and/or a mono valent oxy substituted phospho anion, and
(III) optionally at least one substituent comprising multiple hetero-organo units, optionally one or more repeating oxyhydrocarbylene units which may be the same or 40 different.

12. A process for preparing a polymer as claimed in claim 1; the process comprising the step of:(a)
contacting in a reaction medium:
(i) the constituents ‘a’, ‘b’, ‘c’ and optionally ‘d’ in form of polymer precursors; with
(ii) one or more suitable water soluble polymerization initiator(s) in a total amount above about 0.35% by weight of the total monomer composition.

13. The process as claimed in claim 12 where reaction medium further comprises at least one suitable chain transfer agent(s) in a total amount of less than about 0.05% by weight of the total monomer composition.

14. The process as claimed in claim 13 where reaction medium is substantially free of any chain transfer agents.

15. A pressure sensitive adhesive comprising a polymer as claimed in claim 1.

16. (canceled)

17. A substrate and/or facestock coated with a pressure sensitive adhesive as claimed in claim 15.

18. A substrate and/or facestock as claimed in claim 17 where the substrate and/or facestock comprises plasticizer.

19. The polymer according to claim 1 wherein the activated unsaturated moiety of (c) is at least one ethylenically unsaturated monomer.

20. The polymer according to claim 1 wherein the activated unsaturated moiety of (d) is at least one ethylenically unsaturated monomer.

21. The polymer according to claim 1 wherein the water soluble initiator is present in an amount of up to about 2% by weight of the total monomer composition.

22. The dispersion as claimed in claim 11 wherein the surfactant comprises at least three aromatic rings.

23. The process according to claim 12 wherein the water soluble polymerization initiator(s) is present in the amount of up to about 2% by weight of the total monomer composition.
